(19) United States
(12) Patent Application Publication
(10) Pub. No.: US 2005/0097263 A1
(43) Pub. Date: May 5, 2005

(54) Flash-memory card-reader to IDE bridge

(76) Inventor: Henry Wurzburg, Austin, TX (US)

Correspondence Address: Jeffrey C.Hood;Meyertons Hood, Kivlin, Kowert & Goetzel PC, P.O. Box 398, Austin, TX, 78767, US

(21) Appl. No.: 10/698,093

(22) Filed: Oct. 31, 2003

(51) Int. Cl. G06F 12/00

(52) U.S. Cl. 711/103

(57) ABSTRACT

In one embodiment, the invention comprises a bridge between a flash-memory card-reader and an IDE controller. The IDE controller may be comprised in an embedded system, or any host system configured to communicate with an IDE/ATA interface. In one embodiment, the bridge comprises an IDE/ATA interface coupled to a transmit/receive buffer and an ATA command/status register emulation buffer. The bridge also comprises a control/data bus coupling a processing unit to a respective flash-memory card controller for each device/class type of flash-memory card, and to each buffer. The IDE/ATA interface receives IDE/ATA commands and data from the IDE controller, and the processing unit translates the IDE/ATA commands and status information into control and status information of a format corresponding to the device/class type used by the flash-memory card currently being accessed by the IDE controller. The translated commands are provided to the appropriate flash-memory card controller, allowing for the card controller to communicate with the host system via the host system's IDE controller.

### BACKGROUND OF THE INVENTION

1. Field of the Invention

This invention relates generally to the field of digital interface design and, more particularly, to storage device interface design.

2. Description of the Related Art

In recent years the electronics marketplace has seen a proliferation of appliances and personal electronics devices that use solid-state memory. For example, traditional film cameras have been losing market share to digital cameras capable of recording images that may be directly downloaded to and stored on personal computers (PCs). The pictures recorded by digital cameras can easily be converted to common graphics file formats such as JPEG, GiF or BMP, and sent as e-mail attachments or posted on web pages and online photo albums. Many digital cameras are also capable of capturing short video clips in standard digital video formats, for example MPEG-2, which may also be directly downloaded and stored on PCs or notebook computers. Other devices that typically use solid-state memory include personal digital assistants (PDAs), pocket PCs, video game consoles and MP3 players.

The most widely used solid-state memory devices comprise flash-memory chips configured on a small removable card, and are commonly referred to as flash-memory cards. The majority of flash-memory cards currently on the market are of typically one of four different types: Compact Flash, Multi Media Card (MMC) and the related Secure Digital Card (SD), SmartMedia, and Memory Stick. Most digital cameras, for example, use Compact Flash cards to record images. Many PDA models use Memory Stick cards to hold data. Some MP3 players store music files on Smart Media cards. Generally, data saved by PDAs and other handheld devices using flash-memory cards are also transferred or downloaded to a PC. In the present application, the term “flash-memory” is intended to have the full breadth of its ordinary meaning, which generally encompasses various types of non-volatile solid-state memory devices.

Typically, a flash-memory card can easily be removed from the utilizing device. For example, a Compact Flash card can be removed from a digital camera much like film is removed from a standard camera. The flash-memory card can then be inserted into an appropriate flash-memory card reader hooked up to a PC, and the image files directly copied to the PC. It should be noted that while a majority of smaller hand-held computers and PDAs have slots that receive Compact Flash cards, most PCs do not, hence the need for a flash-memory card reader connecting to the PC. Most recently the preferred interface between flash-memory card readers and PCs has been the Universal Serial Bus (USB), where the flash-memory card reader is connected to a USB port on the PC via a USB cable. Laptop or notebook PCs typically also have PC-card (earlier known as Personal Computer Memory Card International Association; PCMCIA) slots that can receive PCMCIA cards configured as flash-memory card readers.

In all, the many different card formats present a wide array of interface requirements not only for PCs but for other digital systems as well, such as embedded systems for instance. Different adapters are needed for each of the card formats. One solution to consolidate the interfacing of flash-memory cards to desktop and laptop PCs has been the design and manufacture of multi-format flash-memory card readers that are capable of reading the most popular formats. Such card-readers are sometimes referred to as ‘Seven-in-one’ readers indicating that they may be used with the currently popular flash-memory cards formats. As indicated above, such multi-format card readers are typically designed with a USB interface and are connected to host PCs and/or notebook PCs via a USB cable.

USB based systems require that a USB host be present in the host system, and that the operating system (OS) of the host system support USB and USB Mass Storage Class Devices. While this solution is widespread among desktop and standalone systems, it is not widely available in embedded systems, especially currently existing designs. In order to add a flash-memory card reader, or multi-format flash-memory card reader, to an embedded microcontroller based system, an interface, such as a USB interface for USB card readers or a generic microprocessor bus interface card reader controller, would be required to reside on the microcontroller Input/Output (I/O) memory bus. The addition of a specialized interface, such as a USB interface, would necessitate the development of software drivers specific to the hardware configuration and OS used. Generally this would require a large and many times lengthy and expensive development effort, especially when designing a USB interface.

Therefore, there still exists a need for a system and method for designing flash-memory card readers capable of interfacing with host systems, which may be embedded systems, without a need for an additional interface, such as a USB or PCMCIA interface, or a specialized interface, such as a mechanical adapter for Compact Flash Cards.

### SUMMARY OF THE INVENTION

In one set of embodiments the invention comprises a flash-memory card reader to Integrated Drive Electronics (IDE) Bridge (or interface), herein referred to as ‘IDE-CR Bridge’. Generally, flash-memory card media is very similar to hard disk drives (HDDs) in that flash-memory cards are usually formatted in a Windows file format, such as File Allocation Table (FAT) or NT File System (NTFS). In USB multi-format flash-memory card readers the interface for each different card type actually appears as a hard drive to the system via the USB drivers on the host. In one embodiment, the IDE-CR Bridge emulates a standard Advanced Technology Attachment (ATA) HDDs in its software and hardware interface. The internal microprocessor and its program convert the IDE/ATA commands and status/data requests into the formats used by each of the four basic types of Flash Card media. This presents the cards as IDE/ATA HDD to the embedded system/OS, and allows the IDE controllers and drivers that currently exist in the system to be used without requiring an additional specialized interface such as a USB interface or specialized host drivers. The IDE-CR Bridge allows for an instant and transparent addition of flash-memory card reader capability to new and existing embedded systems, and allows the development of a universal and broadly applied device for this function.

In one embodiment, the IDE-CR Bridge comprises an IDE/ATA interface, a transmit/receive (TX/RX) buffer coupled to the IDE/ATA interface, a processing unit coupled to the TX/RX buffer, and a flash-memory card-controller unit coupled to the processing unit and to the TX/RX buffer. A memory, which may be coupled to one or more of the TX/RX buffer, the processing unit, and the flash-memory card-controller unit, may store a software program that implements ATA command/status register emulation. In one embodiment, the ATA command/status register emulation may be built into the IDE/ATA interface, e.g., as physical registers, in lieu of software emulation of the ATA command/status register set.

The IDE/ATA interface may relay IDE/ATA commands received from an IDE controller that may be part of an embedded system to the processing unit. The processing unit may then handle translation of the IDE/ATA commands into commands that are usable by the flash-memory card-controller module. In one embodiment, the flash-memory card-controller module includes individual controller modules for various types of flash-memory cards, for example Compact Flash, Multimedia Card, SmartMedia and Memory Stick. The individual controller modules may be configured to interface with the processing unit and the TX/RX buffer. The translated IDE/ATA commands may be routed to the appropriate individual controller module, giving access to a selected flash-memory card. As a result, individual flash-memory cards may appear as a HDD to the embedded system and may be accessed as a HDD through the embedded system's IDE controller instead of requiring access through an additional interface, such as a USB or a PCMCIA interface. The system and method described therein may also be applied to design a bridge interface to other types of controllers, such as a Small Computer System Interface (SCSI) controller, thus obtaining, for example, a SCSI-CR Bridge.

Therefore, embodiments of the invention may allow the addition of a flash-memory card reader to an embedded system utilizing the embedded system's existing IDE/ATA controller. This obviates the necessity of adding a specialized interface, such as a USB interface, to the embedded system to support the flash-memory card reader.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 illustrates part of an embedded system implemented in accordance with one set of embodiments of the present invention, including an IDE-CR Bridge;

FIG. 2 illustrates a schematic diagram of one embodiment of the IDE-CR Bridge; and

FIG. 3 illustrates a flowchart of a method for operating a flash-memory card-reader.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “coupled” means “directly or indirectly connected”.

### DETAILED DESCRIPTION OF THE PREFERRED EMBODIMENTS

In one embodiment, the invention comprises a system and method for designing a flash-memory card-reader to IDE Bridge (IDE-CR Bridge) to create an interface between a flash-memory card-reader and an IDE controller. The IDE controller may be comprised in an embedded system, or it may be part of a standalone or desktop system, or any other system configured to use an IDE/ATA interface.

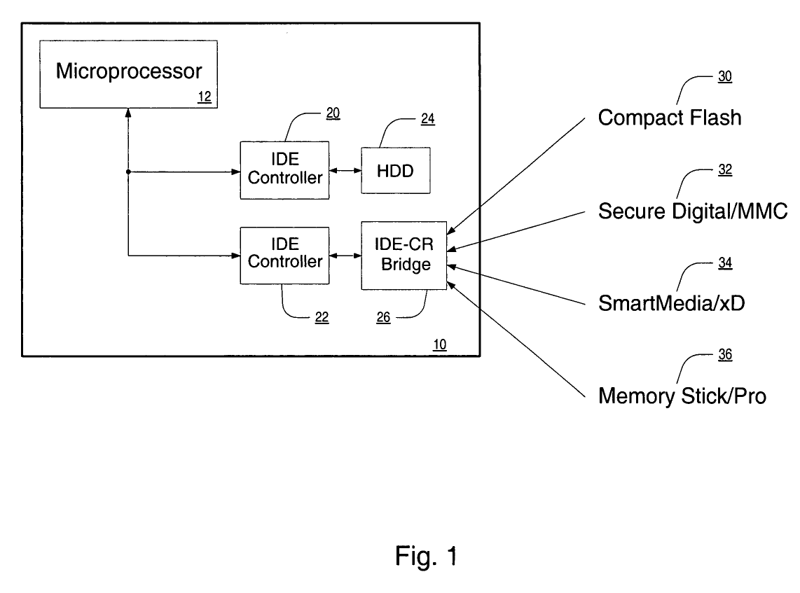

FIG. 1 illustrates part of an embedded system 10 implemented in accordance with one set of embodiments of the present invention. In the embodiment shown in FIG. 1, embedded system 10 includes a microprocessor 12 coupled to a pair of IDE controllers 20 and 22, respectively. IDE controller 20 may be coupled to an HDD 24, and IDE controller 22 may be coupled to an IDE-CR Bridge 26. Various types of flash-memory cards may be coupled to IDE-CR Bridge 26 as shown, including a Compact Flash 30, a Secure Digital/MMC 32, a SmartMedia/xD 34, and a Memory Stick/Memory Stick Pro 36. In one embodiment, IDE-CR Bridge 26 operates to make the various types of flash-memory cards 30, 32, 34 and 36 to appear as hard disk drives to microprocessor 12, where microprocessor 12 may access each flash-memory card as a hard disk drive through IDE controller 22. While FIG. 1 illustrates the most popular types of flash-memory cards coupled to IDE-CR Bridge 26, the scope of the invention is not limited to the types of flash-memory cards shown and IDE-CR Bridge 26 may be configured to receive other types of flash-memory cards.

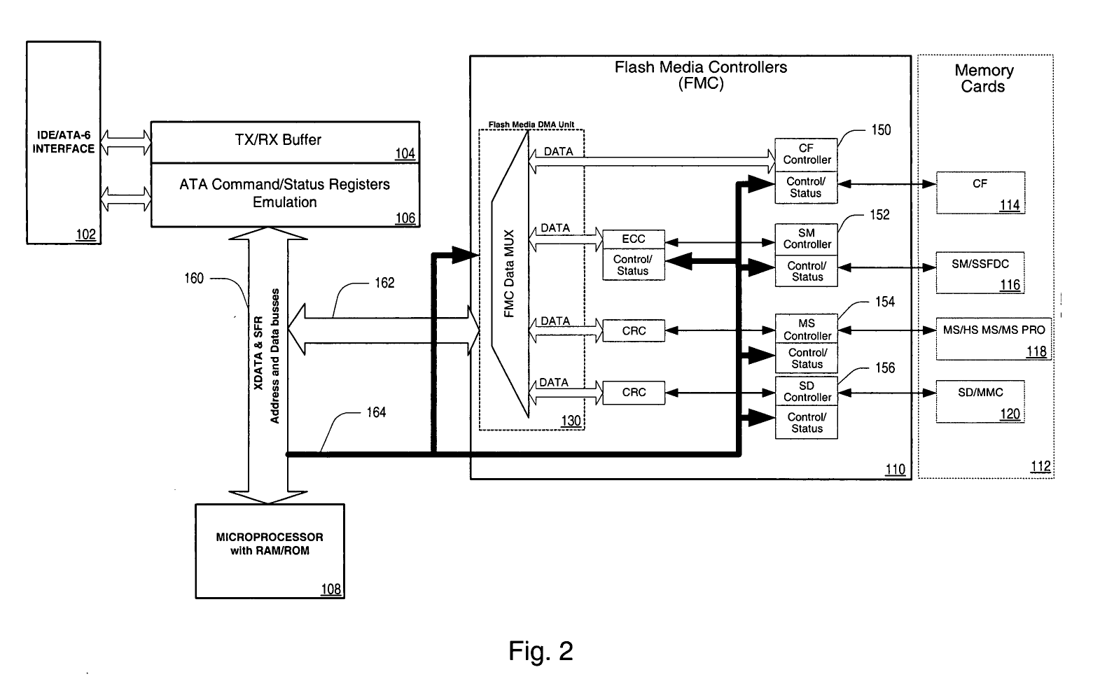

FIG. 2 illustrates a schematic diagram of one embodiment of IDE-CR Bridge 26. In this embodiment, an IDE/ATA interface (IAI) 102 is coupled to a transmit/receive buffer (TRB) 104 and an ATA command/status register emulation buffer (CSRB) 106. IAI 102 may receive IDE/ATA commands and data from an IDE controller configured in a host system, (for example IDE controller 22, as illustrated FIG. 1). The data may be buffered in TRB 104. In one embodiment, CSRB 106 emulates a register structure present in an IDE/ATA device, storing IDE/ATA command and status information that is used by microprocessor 108, which translates the IDE/ATA command and status information into control and status information of a format used by a flash-memory card type corresponding to the device currently being accessed by the IDE controller. An address and data bus 160 may couple CSRB 106 and MP 108, enabling data transfer between MP 108, CSRB 106 and a flash media controller (FMC) unit 110 interfacing with the actual flash-memory cards for exchanging commands/status information.

In one embodiment, FMC 110 comprises individual controller circuits for different types of flash-memory cards, which include a Compact Flash (CF) controller 150, a SmartMedia (SM) controller 152, a Memory Stick (MS) controller 154, and a Secure Digital (SD) controller 156. Transfer of data between a respective flash-memory card and IDE controller 22 may be handled by a flash media DMA unit 130 comprised in FMC 110 and coupled to bus 160 through data bus 162 to TRB 104, through IAI 102. Similarly, transfer of commands (translated by MP 108) between MP 108 and flash-memory card controllers 150, 152, 154, and 156 may take place through control bus 164 coupled into bus 160. FMC 110 may interface with the actual flash-memory cards 112 through appropriate connector slots, where commensurate flash-memory card types may couple to one of the respective flash-media card controllers. For example, controller 150 may manage CF 114, controller 152 may manage SM 116, controller 154 may manage MS 118, and controller 156 may manage SD 120. Flash-memory cards belonging to a same device class/category may be controlled through a single controller; for example 156 may be used to control both SD 120 and MMC 120 type flash-memory cards. Data transferred between IDE controller 22 and a respective flash-memory card may comprise various error correction codes that may be interpreted by the controller handling the respective flash-memory card. For example, controllers 154 and 156 may handle Cyclic Redundancy Codes (CRC), while controller 152 may process Error Correction Codes (ECC).

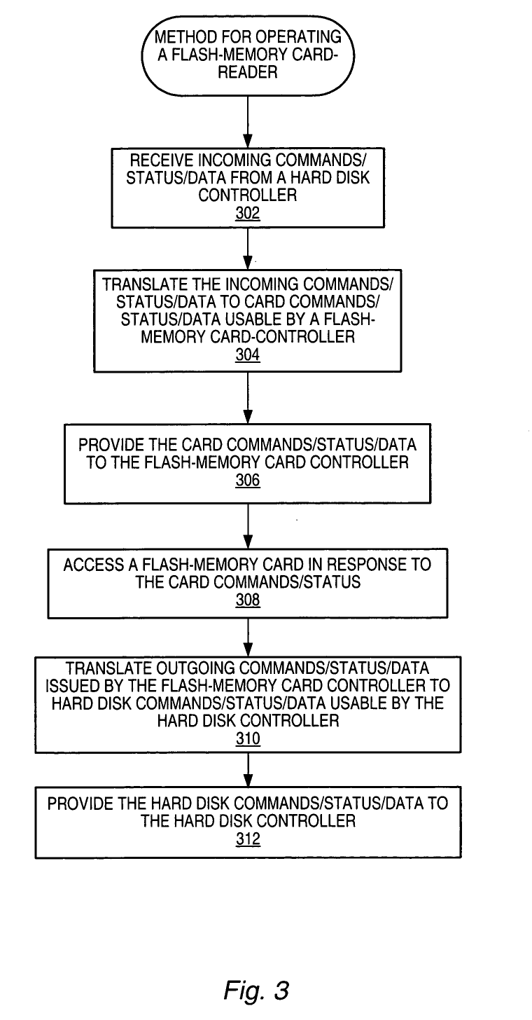

FIG. 3 illustrates a flowchart of part of a method for operating a flash-memory card-reader. A hard disk controller interface may receive incoming commands, status information and data (commands/status/data) from a hard disk controller (302). The hard disk controller may be part of a host system, which may be an embedded system. In one set of embodiments, the hard disk controller may be an IDE controller, while in another set of embodiments it may be a SCSI controller. The incoming commands/status/data may be translated to card commands/status/data that can be interpreted and used by a flash-memory card controller (304). The translation may be performed by a processing unit coupled to the flash-memory card controller. The card commands/status/data may then be provided to the flash-memory card controller, which corresponds to a respective flash-memory card being accessed by the hard disk controller (306). In response to the card commands/status the respective flash-memory card may be accessed (308). In one embodiment, accessing the respective flash-memory card comprises transferring the data to and from the respective flash-memory card as determined by the original incoming commands/status sent by the hard disk controller. The commands may comprise read and/or write commands.

Outgoing commands/status/data generated by the flash-memory card controller may be translated into hard disk commands/status/data usable by the hard disk controller (310), and those hard disk commands/status/data may be provided to the hard disk controller (312). The outgoing commands/status may be generated in response to the incoming commands/status and may comprise read and/or write commands. The flash-memory card reader may comprise more than one flash-memory card controller, one for each selected device/class type of flash-memory card. The processing unit may be programmed to translate the incoming hard disk commands/status/data, for example IDE or SCSI commands/status/data, to a format commensurate with any device/class type format used by the flash-memory card currently accessed by the hard disk controller. Therefore, in one set of embodiments, the invention presents a direct interface between a controller of any type of flash-memory card and a hard disk controller, where the hard disk controller may be configured in an embedded system. Therefore, in one set of embodiments, the invention may present a direct interface between a flash-memory card controller for any type of flash-memory card and an IDE controller, while in another set of embodiments it may present a direct interface between the flash-memory card controller and a SCSI controller. In each respective set of embodiments, microprocessor 108 may be programmed to translate the respective set of hard disk commands and status information into commands interpretable and usable by card controllers 150, 152, 154, and 156.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

1. A flash-memory card-reader system comprising:
a hard disk controller interface;
a buffer coupled to the hard disk controller interface;
a processing unit coupled to the buffer; and
a flash-memory card-controller unit coupled to the buffer and to the processing unit;
wherein the hard disk controller interface is operable to communicate with a hard disk controller in a host system, wherein the hard disk controller interface is operable to receive incoming commands from the hard disk controller; and
wherein the processing unit is operable to translate the incoming commands to produce translated incoming commands usable by the flash-memory card-controller unit, wherein the processing unit is operable to provide the translated incoming commands to the flash-memory card-controller unit.

2. The flash-memory card-reader system of claim 1;
wherein the hard disk controller comprises and IDE/ATA controller; and
wherein the incoming commands are ATA commands.

3. The flash-memory card-reader system of claim 1;
wherein the hard disk controller comprises a SCSI controller; and
wherein the incoming commands are SCSI commands.

4. The flash-memory card-reader system of claim 1;
wherein the flash-memory card-controller unit is operable to access a flash memory card in response to the translated incoming commands.

5. The flash-memory card-reader system of claim 1, further comprising:
a housing comprising at least one slot for receiving a flash-memory card;
wherein the flash-memory card-controller unit is coupled to the housing;
wherein the flash-memory card-controller unit is operable to access the flash-memory card in response to the translated incoming commands.

6. The flash-memory card-reader system of claim 5, wherein the hard disk controller interface, the buffer, the processing unit, and the flash-memory card-controller unit are comprised in the housing.

7. The flash-memory card-reader system of claim 5, wherein the flash-memory card comprises one of a Compact Flash Card, a Secure Digital Card, a Multi Media Card, a Smart Media Card, and a Memory Stick Card.

8. The flash-memory card-reader system of claim 1, further comprising:
a housing comprising one or more slots, wherein each respective one of the one or more slots is configured to receive a respective flash-memory card;
wherein the respective flash-memory card comprises one of the following types:
Compact Flash;
Secure Digital;
Multi Media;
Smart Media; and
Memory Stick; and
wherein the flash-memory card-controller unit is operable to access the respective flash-memory card in response to the translated incoming commands.

9. The flash-memory card-reader system of claim 1, further comprising:
a housing comprising one or more slots, wherein each respective one of the one or more slots is configured to receive a respective flash-memory card;
wherein the respective flash-memory card comprises one or more of the following types:
Compact Flash;
Secure Digital;
Multi Media;
Smart Media; and
Memory Stick; and
wherein the flash-memory card-controller unit is operable to access the respective flash-memory card in response to the translated incoming commands.

10. The flash-memory card-reader system of claim 1;
wherein the flash-memory card-reader system appears as a HDD to the host system.

11. The flash-memory card-reader system of claim 1;
wherein the processing unit is operable to:
translate outgoing commands issued by the flash-memory card-controller unit to produce translated outgoing commands; and
provide the translated outgoing commands to the hard disk controller interface; and
wherein the hard disk controller interface is operable to receive the translated outgoing commands and provide the translated outgoing commands to the hard disk controller in the host system.

12. The flash-memory card-reader system of claim 11, wherein the translated outgoing commands comprise ATA commands.

13. The flash-memory card-reader system of claim 11, wherein the translated outgoing commands comprise SCSI commands.

14. The flash-memory card-reader system of claim 1, further comprising:
an ATA register emulation unit coupled between the buffer and the processing unit, wherein the ATA register emulation unit is configured to store ATA command and status register information.

15. The flash-memory card-reader system of claim 1, further comprising:
a SCSI register emulation unit coupled between the buffer and the processing unit, wherein the SCSI register emulation unit is configured to store SCSI command and status register information.

16. A flash-memory card-reader system comprising:
an IDE/ATA interface;
a buffer coupled to the IDE/ATA interface;
a processing unit coupled to the buffer; and
a flash-memory card-controller unit coupled to the buffer and to the processing unit;
wherein the IDE/ATA interface is operable to communicate with an IDE controller in a host system, wherein the IDE/ATA interface is operable to receive incoming commands from the IDE controller; and
wherein the processing unit is operable to translate the incoming commands to produce translated incoming commands usable by the flash-memory card-controller unit, wherein the processing unit is operable to provide the translated incoming commands to the flash-memory card-controller unit.

17. The flash-memory card-reader system of claim 16, wherein the incoming commands comprise ATA commands.

18. The flash-memory card-reader system of claim 16;
wherein the flash-memory card-controller unit is operable to access a flash memory card in response to the translated incoming commands.

19. The flash-memory card-reader system of claim 16, further comprising:
a housing comprising at least one slot for receiving a flash-memory card;
wherein the flash-memory card-controller unit is coupled to the housing;
wherein the flash-memory card-controller unit is operable to access the flash-memory card in response to the translated incoming commands.

20. The flash-memory card-reader system of claim 19, wherein the IDE/ATA interface, the buffer, the processing unit, and the flash-memory card-controller unit are comprised in the housing.

21. The flash-memory card-reader system of claim 19, wherein the flash-memory card comprises one of a Compact Flash Card, a Secure Digital Card, a Multi Media Card, a Smart Media Card, and a Memory Stick Card.

22. The flash-memory card-reader system of claim 16, further comprising:
a housing comprising one or more slots, wherein each respective one of the one or more slots is configured to receive a respective flash-memory card;
wherein the respective flash-memory card comprises one of the following types:
Compact Flash;
Secure Digital;
Multi Media;
Smart Media; and
Memory Stick; and
wherein the flash-memory card-controller unit is operable to access the respective flash-memory card in response to the translated incoming commands.

23. The flash-memory card-reader system of claim 16, further comprising:
a housing comprising one or more slots, wherein each respective one of the one or more slots is configured to receive a respective flash-memory card;
wherein the respective flash-memory card comprises one or more of the following types:
Compact Flash;
Secure Digital;
Multi Media;
Smart Media; and
Memory Stick; and
wherein the flash-memory card-controller unit is operable to access the respective flash-memory card in response to the translated incoming commands.

24. The flash-memory card-reader system of claim 16;
wherein the flash-memory card-reader system appears as a HDD to the host system.

25. The flash-memory card-reader system of claim 16;
wherein the processing unit is operable to:
translate outgoing commands issued by the flash-memory card-controller unit to produce translated outgoing commands; and
provide the translated outgoing commands to the IDE/ATA interface; and
wherein the IDE/ATA interface is operable to receive the translated outgoing commands and provide the translated outgoing commands to the IDE controller in the host system.

26. The flash-memory card-reader system of claim 25, wherein the translated outgoing commands comprise ATA commands.

27. The flash-memory card-reader system of claim 16, further comprising:
an ATA register emulation unit coupled between the buffer and the processing unit, wherein the ATA register emulation unit is configured to store ATA command and status register information.

28. An integrated circuit, comprising:
an IDE/ATA interface;
a buffer coupled to the IDE/ATA interface;
a processing unit coupled to the buffer; and
a flash-memory card-controller unit coupled to the buffer and to the processing unit;
wherein the IDE/ATA interface is operable to communicate with an IDE controller in a host system, wherein the IDE/ATA interface is operable to receive first commands from the IDE controller; and
wherein the processing unit is operable to translate the first commands to produce second commands usable by the flash-memory card-controller unit, wherein the processing unit is operable to provide the second commands to the flash-memory card-controller unit;
wherein the flash-memory card-controller unit is operable to access a flash memory card in response to the second commands.

29. The integrated circuit of claim 28;
wherein the flash-memory card-reader system appears as a HDD to the host system.

30. The flash-memory card-reader system of claim 28;
wherein the processing unit is operable to:
translate third commands issued by the flash-memory card-controller unit to produce fourth commands; and
provide the fourth commands to the IDE/ATA interface; and
wherein the IDE/ATA interface is operable to receive the fourth commands and provide the fourth commands to the IDE controller in the host system.

31. A system comprising:
at least one IDE controller; and
a flash-memory card-reader interface;
wherein the flash-memory card-reader interface is operable to receive incoming commands from the IDE controller and translate the incoming commands to translated incoming commands usable by a respective flash-memory card;
wherein the flash-memory card-reader interface is further operable to access the respective flash-memory card in response to the translated incoming commands;
wherein the flash-memory card-reader interface is further operable to translate outgoing commands usable by the respective flash-memory card to translated outgoing commands usable by the IDE controller; and
wherein the flash-memory card-reader interface is further operable to provide the translated outgoing commands to the IDE controller.

32. The system of claim 31, wherein the incoming commands and the translated outgoing commands comprise ATA commands.

33. The system of claim 31, further comprising:
a microprocessor coupled to the IDE controller.

34. The system of claim 33, wherein the microprocessor comprises an embedded microprocessor.

35. The system of claim 31, wherein the system comprises an embedded system.

36. The system of claim 31, further comprising:
a housing comprising one or more slots, wherein each respective one of the one or more slots is configured to receive the respective flash-memory card;
wherein the housing is coupled to the flash-memory card-reader interface; and
wherein the respective flash-memory card comprises one of the following types:
Compact Flash;
Secure Digital;
Multi Media;
Smart Media; and
Memory Stick.

37. The system of claim 31, further comprising:
a housing comprising one or more slots, wherein each respective one of the one or more slots is configured to receive the respective flash-memory card;
wherein the housing is coupled to the flash-memory card-reader interface; and
wherein the respective flash-memory card comprises one or more of the following types:
Compact Flash;
Secure Digital;
Multi Media;
Smart Media; and
Memory Stick.

38. A method for operating a flash-memory card-reader, the method comprising:
receiving incoming commands from an IDE controller;
translating the incoming commands to translated incoming commands usable by a flash-memory card-controller and providing the translated incoming commands to the flash-memory card-controller;
accessing a flash-memory card in response to the translated incoming commands;
translating outgoing commands issued by the flash-memory card-controller to translated outgoing commands usable by the IDE controller and providing the translated outgoing commands to the IDE controller.

39. The method of claim 38, wherein the incoming commands and the translated outgoing commands are ATA commands.

40. The method of claim 38, wherein the IDE controller is comprised in an embedded system.

41. The method of claim 38, wherein the outgoing commands issued by the flash-memory card-controller are in response to the translated incoming commands.

42. The method of claim 38, further comprising:
transferring data from the flash-memory card to a host system that comprises the IDE controller;
wherein said accessing comprises obtaining the data from the flash-memory card; and
wherein said transferring is performed in conjunction with said providing the translated outgoing commands to the IDE controller.

43. The method of claim 38, further comprising:
transferring data from a host system that comprises the IDE controller to the flash-memory card;
wherein said accessing comprises writing the data onto the flash-memory card; and
wherein said transferring is performed in conjunction with said providing the translated incoming commands to the flash-memory card-controller.
